(19) United States
(12) Patent Application Publication
(10) Pub. No.: US 2014/0342799 A1
(43) Pub. Date: Nov. 20, 2014

(54) GAME WITH BORDER TRIGGER FEATURE

(71) Applicant: Konami Australia Pty Ltd., Botany NSW (AU)

(72) Inventors: Matthew DEITZ, BOTANY NSW (AU); Gregory DUFFY, BOTANY NSW (AU)

(73) Assignee: Konami Australia Pty Ltd., BOTANY NSW (AU)

(21) Appl. No.: 14/248,871

(22) Filed: Apr. 9, 2014

(30) Foreign Application Priority Data
Apr. 14, 2013 (AU) 2013205634

(51) Int. Cl. G07F 17/32

(52) U.S. Cl. CPC G07F 17/3213
USPC 463/20

(57) ABSTRACT

A method of gaming on a gaming machine; said gaming machine including a game display area in which the number of displayed game elements in a vertical direction is greater than the number of game elements in a horizontal direction; said method including triggering of at least one border differentiating regions of said game elements; said border or borders indicating to a player of a game on said gaming machine the winning of a prize.

### TECHNICAL FIELD

The present invention relates to gaming machines for the playing of games of chance and, more particularly, to special features of games or feature games which may be offered on such machines.

### BACKGROUND

Gaming, or poker machines, have become a major source of amusement and diversion in such places as clubs, hotels and casinos in many parts of the world.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the monetary turnover to the players.

The introduction of electronics, computers and electronic graphical displays, has allowed a continual increase in the complexity and variations of gaming machines, games and displays while maintaining the basic concept of the traditional machine. Nevertheless, in some jurisdictions at least, government regulations effectively restrict the degree of variation which may be incorporated in games played on coin-freed machines.

Machines and games therefore that offer novel and stimulating variations on the basic game theme and environment, yet comply with these restrictions are eagerly sought by the gaming industry and there is consequently intense competition between machine manufacturers to innovate.

Games based on simulated rotatable reels typically display a matrix of elements each of which displays a symbol. Predetermined patterns of symbols, if displayed after the reels are spun and come to rest, may then award a prize to the player of the game. In some known arrangements, a particular outcome of a main game may confer the opportunity to play a feature game.

Nevertheless the repetitive playing of even modern gaming machines can lead to boredom of the players with a consequent under-utilization of machines and increase in player dissatisfaction.

It is an object of the present invention to address or at least ameliorate some of the above disadvantages or provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in one broad form of the invention, there is provided a method of gaming on a gaming machine; said gaming machine including a game display area in which the number of displayed game elements in a vertical direction is greater than the number of game elements in a horizontal direction; said method including triggering of at least one border differentiating regions of said game elements; said to border or borders indicating to a player of a game on said gaming machine the winning of a prize.

Preferably a random outcome of a game played on said gaming machine is displayed as a matrix of said game elements; said matrix comprising an (i) columns by (j) rows matrix of said game elements.

Preferably columns of said matrix of game elements represent simulated spinning reels; predefined patterns of symbols appearing in said game elements at a conclusion of a main game determinant of predefined win outcomes.

Preferably said at least one border comprises a border displayed around the perimeter of said matrix.

The method of any previous claim wherein said at least one border comprises a border displayed around the perimeter of at least one of said columns of said matrix.

Preferably said at least one border comprises differentiating borders displayed around each column of said matrix.

Preferably said at least one border comprises differentiating borders around each game element in a region of game elements.

Preferably said at least one border comprises differentiating borders displayed around at least one column and at least one adjoining game element of an adjacent column.

Preferably said differentiating borders are displayed as coloured outlines around said game elements.

Preferably predefined colours of said differentiating borders denote predefined levels of jackpot prize outcomes.

Preferably said differentiating borders appear during play of said main game.

Preferably said differentiating borders appear at said conclusion of said main game.

Preferably during play of said main game changing patterns of said differentiating borders appear in said display.

Preferably during play of said main game changing patterns of said predefined colours move randomly around one or more of said perimeters.

In yet a further broad form of the invention there is provided a gaming machine for play of a game of chance; said gaming machine including a display sized such that a vertical dimension of said display is greater than a horizontal dimension; said gaming machine programmed to differentiate at least one predefined region of a matrix of game elements of a main game played on said gaming machine; each said at least one predefined region differentiated by a border; colours of said borders indicative to a player of said main game of a win of a jackpot prize.

Preferably said matrix of game elements is comprised of rows and columns; said columns representing simulated spinning reels during play of said main game.

Preferably said at least one predefined region comprise one column of said matrix.

The gaming machine of any one of claims 15 to 17 wherein said at least one predefined region comprises one or more columns of said matrix.

Preferably said at least one predefined region comprises a portion of at least one column of said matrix.

Preferably each of said game elements within a said region is enclosed by a said border.

### BRIEF DESCRIPTION OF DRAWINGS

Embodiments of the present invention will now be described with reference to the accompanying drawings wherein:

FIG. 1 shows a gaming machine for implementation of the border trigger feature of the invention.

FIG. 2 is a view of an alternative form of a gaming machine with top box.

FIG. 3 shows a display of a matrix of game elements with default bordering according to a preferred embodiment of the invention.

FIG. 4 shows the display of FIG. 3 changed from the default border state to a first level jackpot win indicating state.

FIG. 5 shows the display of FIG. 3 changed from the default border state to a second level of jackpot win indicating state.

FIG. 6 shows the display of FIG. 3 changed from the default border stat to a third level of jackpot win indicating state.

FIG. 7 shows the top box of the gaming machine of FIG. 2 with a display indicating the levels of jackpot and the borders indicating wins of the respective jackpot levels.

### DESCRIPTION OF EMBODIMENTS

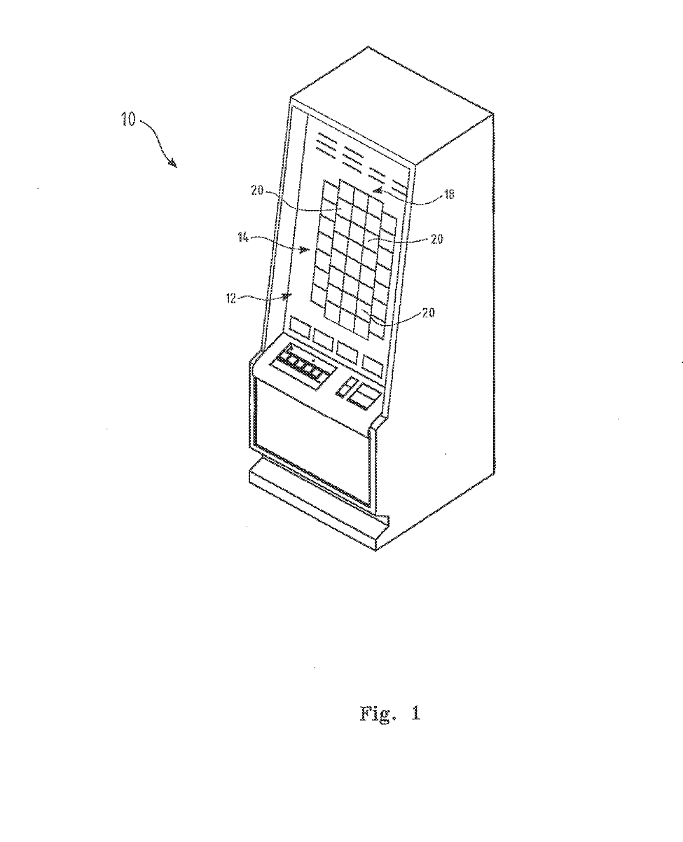

In a preferred embodiment of a game with a border trigger feature according to the invention, the main game of the invention is played on a gaming machine 10, as shown in FIG. 1, provided with a display 12 in which the vertical dimension of the main display area is significantly greater than the horizontal dimension.

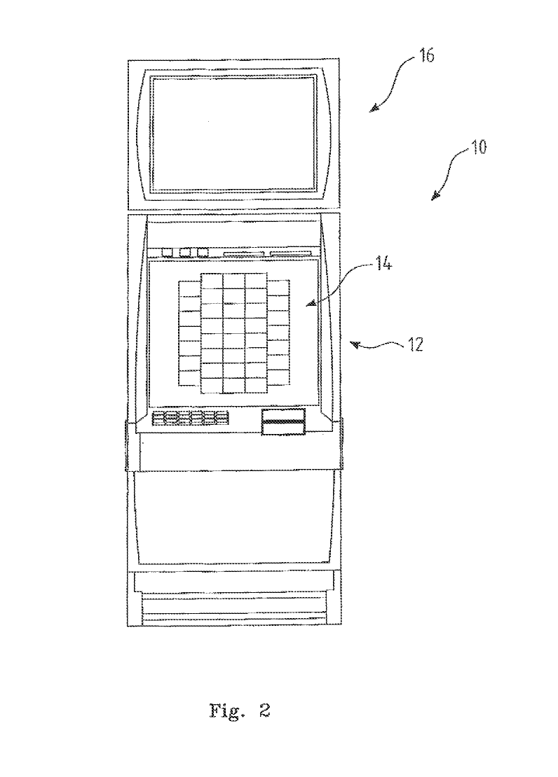

Preferably, the main game occupies a portion of the display, allowing space at least above and below the area 14 of the main game to provide information relating to the main game as well as to a jackpot feature. Alternatively or additionally, information related to the main game and any other features may be displayed in a top box 16 of the gaming machine as shown in FIG. 2.

The main game is in the from of a simulated spinning reel game in which the reels 18 and game elements 20 displayed on the reels form a matrix of game elements when the reels 18 have come to rest after play of a main game sequence. Game elements in this specification refers to symbol containing regions provided on the simulated spinning reels 18 of the main game.

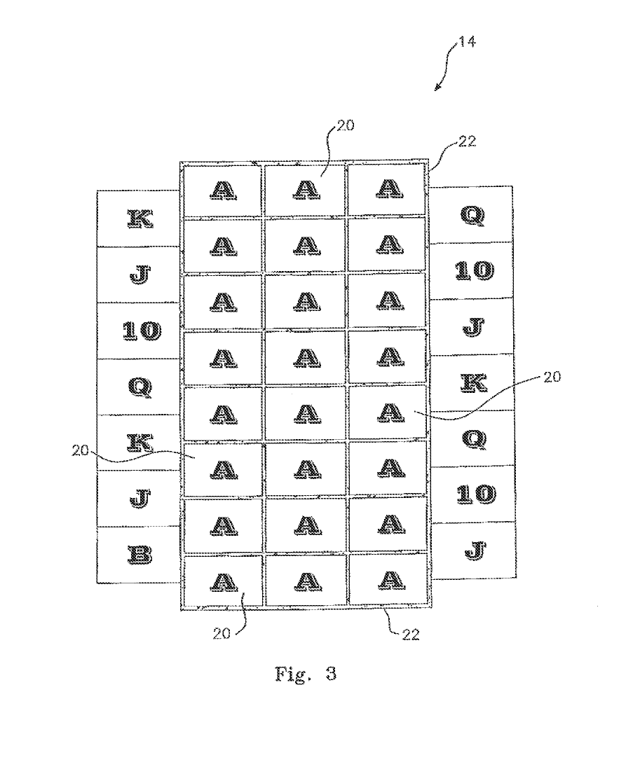

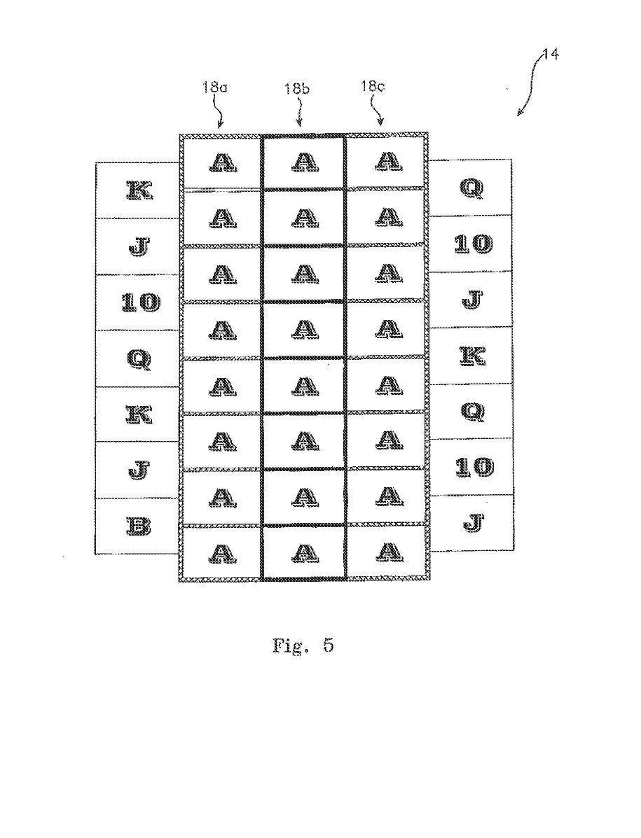

Preferably, the display of the main game forms an (i) column by (j) row matrix of game elements, and is more preferably implemented as three reels each displaying eight game elements when the reels are at rest as more clearly shown in FIGS. 3 to 5.

The border triggering feature of the invention includes the indication of winning outcomes to a player of a game on the gaming machine, through a differentiation of regions of the game elements. Winning outcomes may include those game elements of the main game in which predefined patterns of symbols of the game elements are detected at the end of the main game sequence. More preferably, the border triggering feature indicates to a player that a jackpot prize has been won.

This differentiation of regions of game elements is effected by means of changing the appearance of the default border around a predefined selection of game elements visible in the display at the end of the main game sequence.

In a first preferred embodiment with reference to FIG. 3, the default border 22 is displayed as yellow (shown as cross hatching) around each of the game elements 20 of reels 2, 3 and 4. Should one of a number of predefined arrangements of game element symbols be displayed at the end of a main game sequence, the colour and region of game elements defined by coloured borders is changed from the default colour to a colour indicating a level of jackpot prize to be awarded appropriate to that predefined outcome.

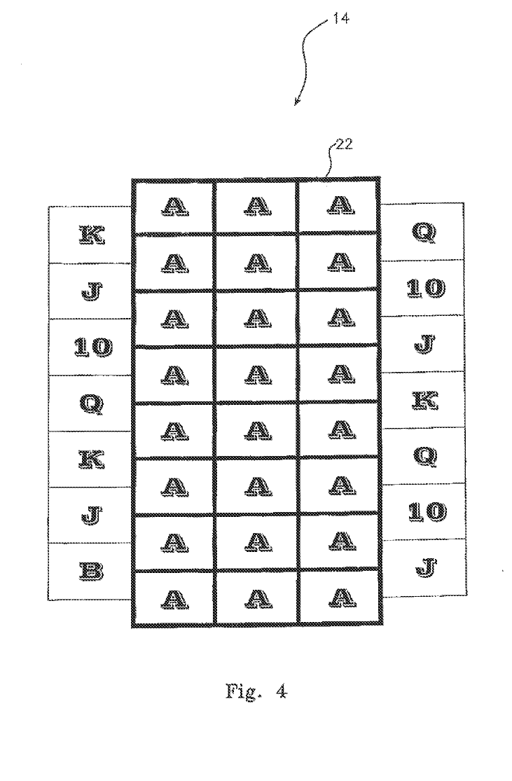

Thus for example, for a first level of jackpot prize, the colour of the border 22 around each of the game elements may change to blue (indicated by a solid fill in FIG. 4). For a second level of jackpot prize the colour may change to green. Not all the game elements need be bordered by the same changed colour, thus for example the elements of the central reel 18b may have borders of one colour, say blue, while the game elements of flanking reels 18a and 18c are bordered by green.

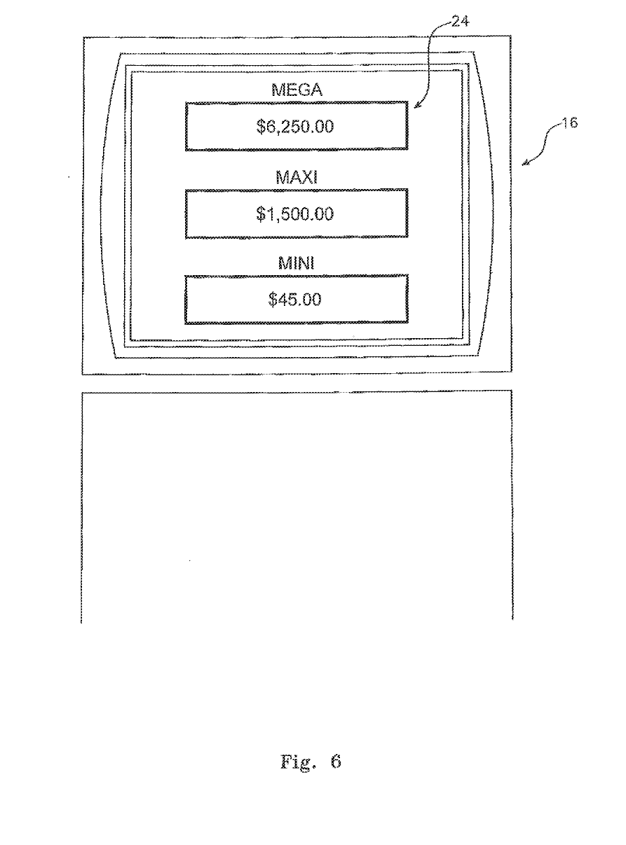

As shown in FIG. 6, in one preferred arrangement, the jackpot prizes which may be won and the border colours indicating such a win, are displayed in the top box 16 of the gaming machine. Thus following the above example, that a MEGA jackpot win has been won may be indicated in the top box display by the default blue border of the MEGA jackpot indicator image 24. Similarly, the top box display indicates the borders (as well as prize values) for MAXI and MINI jackpot prizes.

It will be understood that the bordered regions indicating a jackpot prize need not be restricted to the examples shown in FIGS. 3 to 5. Thus a border may for example enclose all or a portion of the game elements of one reel with the addition of one or more game elements of an adjacent reel. Nor need all the elements within a defined region be surrounded by a border; in one preferred arrangement, the border may extend only around the perimeter of the region.

In one preferred implementation of the border trigger feature of the invention, during the spinning of the reels, the default border colour is varied. For example the border colour may alternate between the default colour and those indicating the various jackpot prizes which may be won. Alternatively, the colour bands or lines of the border may move around the game elements with segments of all the colours following one another in sequence.

### INDUSTRIAL APPLICABILITY

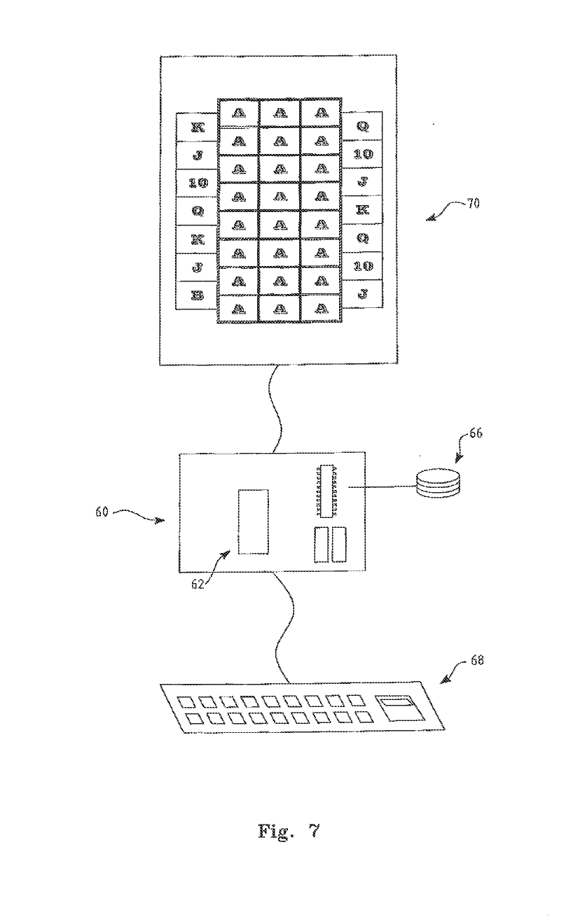

Any of the above described embodiments may be implemented on any gaming machine or group of gaming machines provided with a control module. As shown in FIG. 7, a control module 60 is provided with a microprocessor 62 and working random access memory (RAM) 64. The program code driving any of the described embodiments may be introduced into the control module 60 by connection of a data storage device 66. The device may take any of a number of forms, such as read only memory (ROM), erasable read only memory (EPROM), Compact Flash Card, PCMCIA card and the like. Alternatively, control module 60 may incorporate a hard disc drive to which the code may be written via a suitable input device.

Control module 60 acts to implement appropriate elements of the program code according to inputs from a user keyboard 68 and outputs video imagery to at least a main display module 70.

The above describes only some embodiments of the present invention and modifications, obvious to those skilled in the art, can be made thereto without departing from the scope of the present invention.

1. A method of gaming on a gaming machine; said gaming machine including a game display area in which the number of displayed game elements in a vertical direction is greater than the number of game elements in a horizontal direction; said method including triggering of at least one border differentiating regions of said game elements; said border or borders indicating to a player of a game on said gaming machine the winning of a prize.

2. The method of claim 1, wherein a random outcome of a game played on said gaming machine is displayed as a matrix of said game elements; said matrix comprising an (i) columns by (j) rows matrix of said game elements.

3. The method of claim 1, wherein columns of said matrix of game elements represent simulated spinning reels; predefined patterns of symbols appearing in said game elements at a conclusion of a main game determinant of predefined win outcomes.

4. The method of claim 1, wherein said at least one border comprises a border displayed around the perimeter of said matrix.

5. The method of claim 1, wherein said at least one border comprises a border displayed around the perimeter of at least one of said columns of said matrix.

6. The method of claim 1, wherein said at least one border comprises differentiating borders displayed around each column of said matrix.

7. The method of claim 1, wherein said at least one border comprises differentiating borders around each game element in a region of game elements.

8. The method of claim 1, wherein said at least one border comprises differentiating borders displayed around at least one column and at least one adjoining game element of an adjacent column.

9. The method of claim 8, wherein said differentiating borders are displayed as coloured outlines around said game elements.

10. The method of claim 8, wherein predefined colours of said differentiating borders denote predefined levels of jackpot prize outcomes.

11. The method of claim 8, wherein said differentiating borders appear during play of said main game.

12. The method of claim 8, wherein said differentiating borders appear at said conclusion of said main game.

13. The method of claim 8, wherein during play of said main game changing patterns of said differentiating borders appear in said display.

14. The method of claim 10, wherein during play of said main game changing patterns of said predefined colours move randomly around one or more of said perimeters.

15. A gaming machine for play of a game of chance; said gaming machine including a display sized such that a vertical dimension of said display is greater than a horizontal dimension; said gaming machine programmed to differentiate at least one predefined region of a matrix of game elements of a main game played on said gaming machine; each said at least one predefined region differentiated by a border; colours of said borders indicative to a player of said main game of a win of a jackpot prize.

16. The gaming machine of claim 15, wherein said matrix of game elements is comprised of rows and columns; said columns representing simulated spinning reels during play of said main game.

17. The gaming machine of claim 15, wherein said at least one predefined region comprise one column of said matrix.

18. The gaming machine of claim 15, wherein said at least one predefined region comprises one or more columns of said matrix.

19. The gaming machine of claim 15, wherein said at least one predefined region comprises a portion of at least one column of said matrix.

20. The gaming machine of claim 15, wherein each of said game elements within a said region is enclosed by a said border.
